(19) United States
(12) Patent Application Publication
(10) Pub. No.: US 2014/0009762 A1
(43) Pub. Date: Jan. 9, 2014

(54) MEASUREMENT ASSEMBLY WITH FIBER OPTIC ARRAY

(71) Applicant: NIKON CORPORATION, Tokyo (JP)

(72) Inventor: Daniel Gene Smith, Oro Valley, AZ (US)

(21) Appl. No.: 13/922,867

(22) Filed: Jun. 20, 2013

Related U.S. Application Data
(60) Provisional application No. 61/662,810, filed on Jun. 21, 2012.

(51) Int. Cl. G01N 21/55; G02B 6/26

(52) U.S. Cl. CPC G01N 21/55; G02B 6/262
USPC 356/445; 385/31

(57) ABSTRACT

A measurement assembly (12) that directs a light beam (32) at a surface (16, 56) comprises a light source (20) and a fiber optic array (22). The light source (20) emits the light beam (32) that is directed at the surface (16, 56). Subsequently, the light beam (32) is reflected off of the surface (16, 56) to create a reflected beam (58). The fiber optic array (22) has a first array end (33B) that receives the reflected beam (58). Additionally, the fiber optic array (22) includes a primary fiber (234) and at least one auxiliary fiber (238) that is positioned substantially adjacent to the primary fiber (234) at the first array end (33B). A detector assembly (28) is coupled to the fiber optic array (22) to detect any light from the reflected beam (58) in the primary fiber (234) and the at least one auxiliary fiber (238).

### RELATED INVENTION

This application claims priority on U.S. Provisional Application Ser. No. 61/662,810, filed Jun. 21, 2012 and entitled “MEASUREMENT ASSEMBLY WITH FIBER OPTIC ARRAY”. As far as permitted, the contents of U.S. Provisional Application Ser. No. 61/662,810 are incorporated herein by reference.

### BACKGROUND

Laser metrology systems can be utilized for various purposes. For example, laser metrology systems, such as a laser radar system, can be utilized for precise dimensional measurement or verification of one or more features on surfaces of objects such as manufactured parts, for precise dimensional measurement or verification of such objects, to measure the distance to and the three-dimensional location of such objects, and/or to track the location and movement of such objects. As large manufactured parts increase in complexity and cost, the need for improved measurement systems increases so that such manufactured parts can be manufactured and/or assembled precisely and accurately the first time.

Unfortunately, currently available metrology systems are not entirely satisfactory.

### SUMMARY

The present invention is directed toward a measurement assembly that directs a light beam at a surface. In certain embodiments, the measurement assembly includes a light source and a fiber optic array. The light source emits the light beam that is directed at the surface. Subsequently, the light beam is reflected off of the surface to create a reflected beam. The fiber optic array has a first array end that receives the reflected beam. Additionally, the fiber optic array includes a primary fiber and at least one auxiliary fiber. The at least one auxiliary fiber is positioned substantially adjacent to the primary fiber at the first array end.

With the unique design of the measurement assembly, as provided herein, the measurement assembly is able to quickly and accurately measure one or more properties of an object. For example, the measurement assembly can be utilized to track the movement of the object without the need for w-scanning or other similar moving or scanning features.

In some embodiments, the measurement assembly further comprises a detector assembly that is coupled to the fiber optic array. In such embodiments, any light from the reflected beam in the primary fiber provides a measurement beam that is detected by the detector assembly to generate a primary signal, and any light from the reflected beam in the at least one auxiliary fiber is detected by the detector assembly to generate at least one auxiliary signal. In one such embodiment, the detector assembly includes a primary detector and at least one auxiliary detector. In such embodiment, the measurement beam is detected by the primary detector to generate the primary signal, and light from the reflected beam in the at least one auxiliary fiber is detected by the at least one auxiliary detector to generate the at least one auxiliary signal.

Additionally, in certain embodiments, the measurement assembly further comprises a control system that receives the primary signal and the at least one auxiliary signal. The control system utilizes at least the primary signal to measure a property of the surface. Further, the measurement system can also comprise a beam steering assembly that selectively adjusts the position of the light beam relative to the surface. In one embodiment, the control system can utilize the at least one auxiliary signal to control the beam steering assembly.

Further, in some embodiments, the measurement assembly further comprises an optical assembly that is positioned along a beam path of the light beam between the fiber optic array and the surface. The optical assembly focuses the light beam to provide a focused beam that is directed at the surface. In certain embodiments, the surface can be curved. In such embodiments, the measurement assembly can further comprise a detector assembly that is coupled to the fiber optic array, wherein any light from the reflected beam in the primary fiber provides a measurement beam that is detected by the detector assembly to generate a primary signal, and any light from the reflected beam in the at least one auxiliary fiber is detected by the detector assembly to generate at least one auxiliary signal. Additionally, the at least one auxiliary signal can be utilized to center the focused beam on the curved surface. Moreover, in one embodiment, the surface can be part of a spherical target. In such embodiment, the optical assembly can be selectively adjustable so that the focused beam is focused on one of the surface of the spherical target and the center of curvature of the spherical target. Still further, in one embodiment, the reflected beam can be directed toward the optical assembly, with the optical assembly focusing the reflected beam onto one or more of the primary fiber and the at least one auxiliary fiber.

In certain embodiments, the fiber optic array includes a plurality of auxiliary fibers, wherein the plurality of auxiliary fibers are positioned substantially adjacent to and substantially encircle the primary fiber at the first array end. In such embodiments, the measurement assembly can further comprise a detector assembly that is coupled to the fiber optic array, wherein any light from the reflected beam in the primary fiber provides a measurement beam that is detected by the detector assembly to generate a primary signal, and any light from the reflected beam in the plurality of auxiliary fibers is detected by the detector assembly to generate a plurality of auxiliary signals. In one such embodiment, the measurement assembly can further comprise a beam steering assembly that selectively adjusts the position of the light beam relative to the surface, and a control system that receives the primary signal and the plurality of auxiliary signals. The control system controls the beam steering assembly utilizing the plurality of auxiliary signals.

Additionally, in one application, the present invention is directed toward a method for directing a light beam at a surface, the method comprising the steps of (i) emitting the light beam from a light source; (ii) directing the light beam at the surface; (iii) reflecting the light beam off of the surface to create a reflected beam; and (iv) receiving the reflected beam with a first array end of a fiber optic array, the fiber optic array including a primary fiber and at least one auxiliary fiber, wherein the at least one auxiliary fiber is positioned substantially adjacent to the primary fiber at the first array end.

Further, in one application, the present invention is also directed toward a measurement assembly that directs a light beam at a curved surface, the measurement assembly comprising: (i) a light source that emits the light beam; (ii) a fiber optic array having a first array end, an opposed second array end, a primary fiber and a plurality of auxiliary fibers, wherein the primary fiber is coupled into and receives the light beam at the first array end, and wherein the plurality of auxiliary fibers are positioned substantially adjacent to and that substantially encircle the primary fiber at the second array end; (iii) an optical assembly that is positioned along a beam path of the light beam between the fiber optic array and the surface, the optical assembly focusing the light beam to provide a focused beam; (iv) a beam steering assembly that directs the focused beam toward the curved surface, the focused beam subsequently being reflected off of the curved surface to provide a reflected beam that is directed toward the optical assembly, wherein the optical assembly focuses the reflected beam onto one or more of the primary fiber and the plurality of auxiliary fibers; (v) a detector assembly that is coupled to the fiber optic array, wherein any light from the reflected beam in the primary fiber provides a measurement beam that is detected by the detector assembly to generate a primary signal, and any light from the reflected beam in the plurality of auxiliary fibers is detected by the detector assembly to generate a plurality of auxiliary signals; and (vi) a control system that receives the primary signal and the plurality of auxiliary signals, wherein the control system utilizes at least the primary signal to measure a property of the surface, and wherein the control system utilizes the plurality of auxiliary signals to control the beam steering assembly such as to center the focused beam on the curved surface.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1 is a simplified schematic illustration of an object and an embodiment of a measurement assembly having features of the present invention, the measurement assembly providing a focused beam that is focused at a first position;

FIG. 2 is a simplified end view of an embodiment of a fiber optic array that is usable as part of the measurement assembly of FIG. 1;

FIG. 3A is a simplified schematic illustration of the object and the measurement assembly of FIG. 1, the measurement assembly providing the focused beam that is focused at a second position;

FIG. 3B is an enlarged view of a portion of the object and the focused beam (as indicated by a circle and reference “B-B” in FIG. 3A);

FIG. 4A is a simplified schematic illustration of the object and the measurement assembly of FIG. 1, the measurement assembly providing the focused beam that is focused at a third position;

FIG. 4B is an enlarged view of a portion of the object and the focused beam (as indicated by a circle and reference “B-B” in FIG. 4A);

FIG. 5 is a block diagram of a structure manufacturing system having features of the present invention; and

FIG. 6 is a flowchart showing a processing flow of the structure manufacturing system of FIG. 5.

### DESCRIPTION

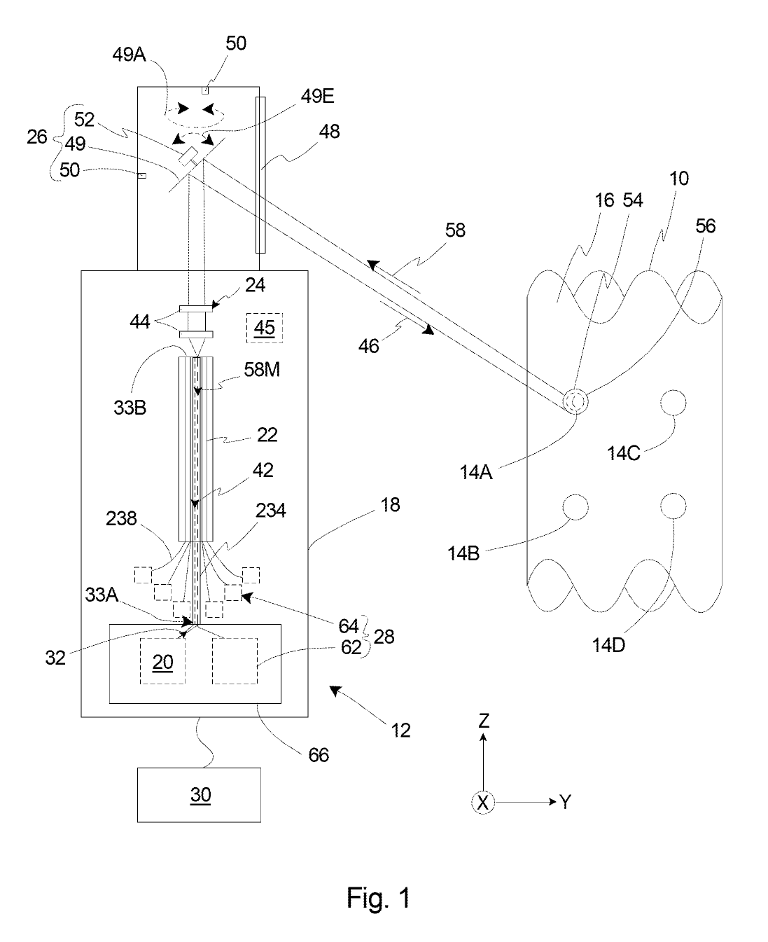

FIG. 1 is a simplified schematic illustration of an object 10 and an embodiment of a measurement assembly 12 having features of the present invention. As illustrated, the object 10 can include one or more features 14A-14D (feature 14A is illustrated in phantom), e.g., bolt holes or other relevant features, which are present on a surface 16 of the object 10. In certain embodiments, the measurement assembly 12 can be utilized for measuring a property of the object 10 and/or a property of a surface, e.g., the surface 16 of the object 10. More particularly, FIG. 1 illustrates the measurement assembly 12 being utilized to measure one of the features 14A that is present on the surface 16 of the object 10. Additionally, the shape of the surface (flat, curved, etc.) and/or the type of property being measured by the measurement assembly 12 can vary. For example, an operator may wish to accurately measure the size, the location of, i.e. the X-Y-Z coordinates, and/or the distance to and between the one or more features 14A-14D on the surface 16 of the object 10. Additionally and/or alternatively, the operator may wish to accurately track the movement of the object 10 and/or the movement of one or more of the features 14A-14D of the object 10. Further, in certain applications, the measurement assembly 12 can be used with regard to objects 10 such as manufactured parts that can be used with or can include giant aircraft parts, composites, wind turbines, concentrated solar panels, antennae, telescopes, ship hulls and propellers, heated surfaces, etc. Moreover, the measurement assembly 12 can be used for such applications as quality assurance, routine and event driven inspection procedures, in-process applications such as component alignment and robotic positioning, tool building and alignment, tool or model digitalization, etc.

A number of Figures include an orientation system that illustrates an X axis, a Y axis that is orthogonal to the X axis, and a Z axis that is orthogonal to the X and Y axes. It should be noted that any of these axes can also be referred to as the first, second, and/or third axes.

The design of the measurement assembly 12 can be varied depending on the desired usages for the measurement assembly 12. In FIG. 1, the measurement assembly 12 includes an assembly body 18, a light source 20 (illustrated as a box in phantom), a fiber optic array 22, an optical assembly 24, a beam steering assembly 26, a detector assembly 28 (illustrated as a plurality of boxes in phantom), and a control system 30.

As an overview, in certain embodiments, the measurement assembly 12 is simple and inexpensive to manufacture and use, and is uniquely designed to enable quick and accurate measurement of a surface, e.g., quick and accurate measurement of the one or more features 14A-14D on the surface 16 of the object 10. Additionally, the measurement assembly 12 can be utilized to track the movement of the object 10 without the need for w-scanning or other similar moving or scanning features.

The assembly body 18 is designed to provide a rigid housing for some or all of the other elements of the measurement assembly 12. For example, in FIG. 1, the light source 20, the fiber optic array 22, the optical assembly 24, the beam steering assembly 26, and the detector assembly 28 can all be positioned within the assembly body 18. Additionally, the assembly body 18 can be constructed from any suitable, rigid, materials. It should be noted that the assembly body 18 is illustrated in FIG. 1 as being substantially transparent for purposes of clarity, i.e. so that the various elements can be seen as they are positioned and/or enclosed within the assembly body 18, and such transparency of the assembly body 18 is not intended to limit the breadth and scope of the present invention.

The design of the light source 20 can be varied to suit the specific requirements of the measurement assembly 12. In one embodiment, the light source 20 can be a laser-based light source that generates and/or emits a light beam 32 (indicated with an arrow in FIG. 1), e.g., a laser beam, which can be directed toward and/or coupled into the fiber optic array 22. In some embodiments, the light beam 32 can have a wavelength that is in the infrared range, i.e. the light beam 32 can have a wavelength of between approximately 700 nm and one mm. Alternatively, the light beam 32 can include a wavelength that is outside the infrared range. Moreover, in certain embodiments, it is desired that the wavelength of the light beam 32 be such as to minimize any risk of injury to the eyes of the operator or others. For example, light beams of approximately 1.5 μm are considered to be relatively eye-safe at higher power levels and thus such light beams may be usable for certain applications.

Additionally, in alternative embodiments, the light beam 32 that is generated and/or emitted by the light source 20 can be a continuous light beam 32, or the light beam 32 that is generated and/or emitted by the light source 20 can be a pulsed light beam 32.

As shown in this embodiment, the fiber optic array 22 includes a first array end 33A and an opposed second array end 33B. During use, the first array end 33A of the fiber optic array 22 receives the light beam 32 from the light source 20. Stated in another fashion, the light beam 32 from the light source 20 can be directed toward and/or coupled into the first array end 33A of the fiber optic array 22. Subsequently, the light beam 32 traverses the length of the fiber optic array 22 and then exits from the second array end 33B of the fiber optic array 22 toward the optical assembly 24.

It should be noted that the use of the terms “first array end” and “second array end” is merely for purposes of convenience of description, and either end of the fiber optic array 22 can be referred to as the first array end and/or the second array end.

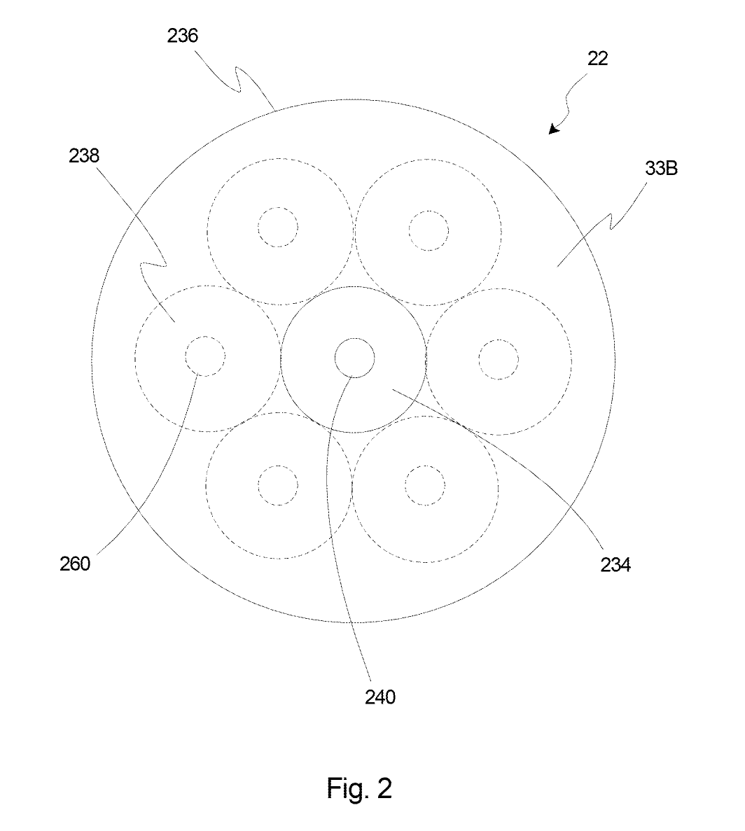

FIG. 2 is a simplified end view of an embodiment of the fiber optic array 22 that is usable as part of the measurement assembly 12 of FIG. 1. In particular, FIG. 2 is a simplified end view of the fiber optic array 22 looking at the second array end 33B of the fiber optic array 22. In this embodiment, the fiber optic array 22 includes a primary fiber 234 that is substantially centrally positioned within a fiber sleeve 236, and a plurality of auxiliary fibers 238. Additionally, as shown, the plurality of auxiliary fibers 238 are positioned substantially adjacent to the primary fiber 234 at the second array end 33B. Moreover, in this embodiment, the plurality of auxiliary fibers 238 substantially encircle the primary fiber 234 at the second array end 33B.

It should be noted that FIG. 2 does not illustrate how the plurality of auxiliary fibers 238 can be positioned and/or extend away from the primary fiber 234 toward the first array end 33A (illustrated in FIG. 1) for purposes of clarity.

During use, in the particular embodiment illustrated herein, the light beam 32 (illustrated in FIG. 1) is directed toward and/or coupled into the primary fiber 234 at the first array end 33A, such that the light beam 32 traverses the length of the primary fiber 234 and exits the primary fiber 234 at the second array end 33B toward and/or into the optical assembly 24 (illustrated in FIG. 1). Additionally, as illustrated, the primary fiber 234 has a fiber tip 240 (illustrated for simplicity as a small circle substantially centrally located within the cross-section of the primary fiber 234), and at least a majority of the light from the light beam 32 is directed toward and/or coupled into the optical assembly 24 through the fiber tip 240.

Further, in some embodiments, a small portion of the light beam 32 can be inhibited from exiting the primary fiber 234 toward and/or into the optical assembly 24 so as to provide a reference beam 42 (illustrated with a short dashed line within the primary fiber 234, and with an arrow in FIG. 1). For example, in one non-exclusive embodiment, the fiber tip 240 can have a partially reflective surface or coating that reflects a portion of the light beam 32 back toward the light source 20 (illustrated in FIG. 1) as the reference beam 42. Alternatively, the fiber optic array 22, e.g., the primary fiber 234, can include a beam splitter (not illustrated) that splits the light beam 32 such that a majority of the light beam 32 is directed toward and/or coupled into the optical assembly 24, while a small portion of the light beam is directed back toward the light source 20 as the reference beam 42. Still alternatively, the reference beam 42 can be provided in a different manner, e.g., internal to the optical assembly 24.

In certain applications, as provided herein, the light source 20 may be intended to be operated in a distance measuring scheme. In such applications, if the distance measurement scheme involves interference with a reference path, e.g., with the reference beam 42, the light beam 32 from the light source 20 will require some degree of temporal coherence. Stated in another manner, the light beam 32 from the light source 20 will need a coherence length longer than the distance to the surface minus whatever reference distance is used. Additionally and/or alternatively, in the case of true time of flight measurement, the light source 20 is pulsed in some manner, and so it will necessarily acquire some somewhat shorter coherence length.

The fiber sleeve 236 encircles the primary fiber 234 and the plurality of auxiliary fibers 238 and is utilized to effectively join together and maintain the relative orientation of the primary fiber 234 and the auxiliary fibers 238. Additionally, in alternative embodiments, the fiber sleeve 236 can be designed to extend part way or substantially all the way along the length of the primary fiber 234 and the auxiliary fibers 238. Further, in one embodiment, the fiber sleeve 236 is made of a plastic material. Alternatively, the fiber sleeve 236 can be made of a metallic or fiberglass material, or another suitable material.

As noted above, in the embodiment illustrated in FIG. 2, the plurality of auxiliary fibers 238 are positioned substantially adjacent to the primary fiber 234 and substantially encircle the primary fiber 234 at the second array end 33B. Additionally, the auxiliary fibers 238 extend substantially parallel to the primary fiber 234 within the fiber sleeve 236. In this embodiment, the fiber optic array 22 includes six auxiliary fibers 238 that are substantially adjacent to and that substantially encircle the primary fiber 234 at the second array end 33B. Alternatively, the fiber optic array 22 can be designed with less than six or greater than six auxiliary fibers 238. Additionally and/or alternatively, the auxiliary fibers 238 can be positioned such that they do not substantially encircle the primary fiber 234 at the second array end 33B. For example, in certain non-exclusive alternative embodiments, the fiber optic array 22 can include one, two, three, four, eight, twelve or eighteen auxiliary fibers 238, and the auxiliary fibers 238 may or may not substantially encircle the primary fiber 232 at the second array end 33B.

Returning back to FIG. 1, as noted above, at least a majority of the light from the light beam 32 is directed toward and/or coupled into the optical assembly 24 through the fiber tip 240 (illustrated in FIG. 2) of the primary fiber 234. The design and positioning of the optical assembly 24 can be varied to suit the specific requirements of the measurement assembly 12 and/or to accommodate the specific features of the light source 20 and the light beam 32. It should be noted that wherever the optical assembly 24 is positioned, the optical assembly 24 is still positioned such that it is coupled into and/or substantially adjacent to the fiber optic array 22.

In some embodiments, the optical assembly 24 is positioned along a beam path of the light beam 32 between the fiber optic array 22 and the object 10. For example, in the embodiment illustrated in FIG. 1, the optical assembly 24 is coupled to and positioned substantially adjacent to the fiber optic array 22 along the beam path of the light beam 32 between the fiber optic array 22 and the beam steering assembly 26. Alternatively, the optical assembly 24 can be positioned along a different portion of the beam path of the light beam 32 between the fiber optic array 22 and the object 10, e.g., the optical assembly 24 can be integrated into the beam steering assembly 26 and/or the optical assembly 24 can be positioned along the beam path of the light beam 32 between the beam steering assembly 26 and the object 10. Simply stated, in various alternative embodiments, the optical assembly 24 can be positioned at any suitable location along the beam path of the light beam 32 between the fiber optic array 22 and the object 10. As provided herein below, in certain alternative embodiments, the positioning of the fiber optic array 22 can be varied relative to the beam steering assembly 26; however, in each such embodiment, the optical assembly 24 is still positioned such that it is coupled into and/or substantially adjacent to the fiber optic array 22.

Additionally, as noted above, at least a majority of the light beam 32 is directed toward and/or coupled into the optical assembly 24. In certain embodiments, the optical assembly 24 can include one or more optical elements 44, e.g., lenses, that cooperate to focus the portion of the light beam 32 received by the optical assembly 24 to provide a focused light beam 46 (indicated with an arrow in FIG. 1, and also referred to herein as a “focused beam”). More specifically, the optical elements 44 collect light from the light beam 32 from the fiber tip 240 (illustrated in FIG. 2) of the primary fiber 234 and focus that light to provide the focused beam 46.

Further, as discussed herein, the optical assembly 24 can be selectively adjusted with a mover 45 (illustrated as a box) under control of the control system 30 so that the light beam 32 can be focused in the specific manner desired to provide the focused beam 46. For example, in one embodiment, the control system 30 can selectively control the movement of the optical elements 44 so that the focused beam 46 is focused properly, as discussed herein, toward and/or onto the object 10. Additionally, in certain embodiments, the means of focusing the light beam 32 to provide the focused beam 46 can be accomplished with one or more of a zoom lens, LCD, Alvarez lens, moving retroreflector, liquid lens, etc.

In FIG. 1, the focused beam 46 is initially directed from the optical assembly 24 toward the beam steering assembly 26. Subsequently, the focused beam 46 is then redirected by the beam steering assembly 26 through an aperture 48 or window in the assembly body 18 of the measurement assembly 12 and toward the object 10. For example, in one embodiment, the beam steering assembly 26 includes a beam steerer 49, e.g., a mirror or other suitably reflective surface, that redirects the focused beam 46 toward the object 10. Additionally, in some embodiments, the beam steering assembly 26 can include bearings (not illustrated) so that the beam steering assembly 26 is selectively adjustable in tip and tilt (rotation about two axes). With this design, the beam steering assembly 26 can accurately and precisely steer the focused beam 46 toward the object 10 under the control of the control system 30. Stated another way, the control system 30 can selectively control the azimuth angle (about the Z axis) and the elevation angle (relative to the X-Y plane) of the beam steering assembly 26 in order to accurately steer the focused beam 46 toward the object 10 as desired. The rotation and/or angling of the beam steerer 49 about the Z axis for control of the azimuth angle is illustrated in FIG. 1 with dashed line and arrows 49A; and the rotation and/or angling of the beam steerer 49 relative to the X-Y plane for control of the elevation angle is illustrated in FIG. 1 with dashed line and arrows 49E. In certain embodiments, due to the adjustability of the beam steering assembly 26, the measurement assembly 12 can exhibit a field of view having an azimuth angle of approximately 360 degrees and elevation angles of plus or minus forty-five degrees from the horizontal, i.e. relative to the X-Y plane in FIG. 1. Alternatively, other azimuth and elevation angles are also possible. With this design, the measurement system 12 is able to look at different objects, look at objects at different angles, and/or to focus over a certain distance range.

Moreover, as shown in FIG. 1, the beam steering assembly 26 can further include one or more encoders 50 (two are shown in FIG. 1) and one or more motors 52 (only one is shown in FIG. 1). In one embodiment, the encoders 50 and/or the motors 52 can be positioned substantially adjacent to and/or coupled to the beam steerer 49. The encoders 50 can be in communication with the control system 30 to provide information (feedback) about the positioning of the beam steering assembly 26, e.g., the beam steerer 49, relative to the object 10. For example, the encoders 50 can provide information to the control system 30 regarding the specific positioning of the beam steering assembly 26, i.e. the specific azimuth and elevation angles of the beam steering assembly 26. Further, the motors 52 can be controlled by the control system 30 based on the information provided by the encoders 50 to selectively adjust the positioning of the beam steering assembly 26 as desired so that the focused beam 46 can be precisely and accurately steered as desired toward the object 10.

In certain alternative embodiments, the position and/or orientation of at least a portion of the fiber optic array 22 can be selectively adjusted by the control system 30 to selectively control the azimuth angle and/or the elevation angle of the light beam 32 and/or the focused beam 46. For example, in one such embodiment, the position and/or orientation of the fiber tip 240 of the primary fiber 234 can be selectively adjusted by the control system 30 to selectively control one or more of the azimuth angle and the elevation angle. In such embodiment, the second array end 33B can be angled relative to the first array end 33A for desired steering of the light beam 32 and/or the focused beam 46. Additionally, in such embodiment, the beam steering assembly 26 may then only be required for providing whatever adjustments are desired for the elevation and azimuth angles that are not provided through the selective positioning and/or orientation of the fiber tip 240. Further, in such embodiment, the optical assembly 24 is still coupled into and/or substantially adjacent to the fiber optic array 22 to receive the light beam 32 and to focus the light beam 32 as desired to provide the focused beam 46 that is steered toward the object 10.

The control system 30 can include one or more processors and circuits. Additionally, the control system 30 is electrically connected to and controls the various features and functions of the measurement assembly 12. For example, the control system 30 can be utilized (i) to control the generation and emission of the light beam 32 from the light source 20, (ii) to control the focusing of the light beam 32 into a proper focused beam 46 by moving the optical elements 44 of the optical assembly 24 as necessary, and (iii) to control the positioning of the beam steering assembly 26 so that the focused beam 46 can be precisely and accurately steered toward the object 10. In one embodiment, as illustrated in FIG. 1, the control system 30 can be positioned outside of and remote from the assembly body 18. Alternatively, the control system 30 can be positioned substantially within the assembly body 18.

In certain embodiments, a target 54 can be secured or otherwise coupled to the object 10, e.g., secured or otherwise coupled to one of the one or more features 14A-14D on the surface 16 of the object 10, and the focused beam 46 can be directed toward the target 54. More particularly, as illustrated, the target 54 can include a target surface 56, and the focused beam 46 can be directed at the target surface 56.

In one embodiment, the target 54 can be a spherical ball, e.g., a ball bearing, having a specular, reflective surface 56 that reflects and/or scatters the focused beam 46 back toward the measurement assembly 12. As such, the target 54 can provide a reflected beam 58 (illustrated with an arrow in FIG. 1) that is reflected and/or scattered back toward the measurement assembly 12. Stated in another manner, in such embodiment, the focused beam 46 impinging on the target surface 56 can reflect off of and/or scatter from the target surface 56 back toward the measurement assembly 12 as the reflected beam 58. As shown in FIG. 1, the target 54 can be secured or otherwise coupled to one of the features 14A on the surface 16 of the object 10 to enable the measurement assembly 12 to accurately and precisely measure the location of the feature 14A. Alternatively, the target 54 can have a different design than that described herein. For example, the target 54 can be formed of only a portion of a sphere that can be secured or otherwise coupled to the object 10, i.e. to the surface 16 of the object 10.

As the focused beam 46 is being steered and focused toward the object 10, i.e. toward the surface 16 of the object 10 and/or toward the surface 56 of the target 54, the focus condition and/or the surface position of the focused beam 46 can vary. As provided herein, the information that can be learned from the reflected beam 58 being reflected back toward the measurement assembly 12 can be used to ensure that the focused beam 46 is steered and focused toward the object 10 precisely as desired.

In certain applications of the present invention, the focused beam 46 can have different focus conditions such that it can be focused on a surface, e.g., on a curved surface such as the surface 56 of the target 54 (referred to as “focus condition one”), at the center of curvature of such a curved surface (referred to as “focus condition two”), and/or close to the surface or close to the center of curvature (referred to as “focus condition three”). Additionally, in certain applications, the focused beam 46 can have different surface positions relative to the surface at which the focused beam 46 is focused. In particular, the focused beam 46 can have a surface normal position (i.e. normal incidence), wherein the central ray of the focused beam 46 is normally incident on the surface (referred to as “surface normal position one”), which can apply to any of the focus conditions noted above; and/or the focused beam 46 can have a not surface normal position, wherein the central ray of the focused beam 46 is not normally incident on the surface (referred to as “surface normal position two”).

In focus condition one and surface normal position one, the focused beam 46 is refocused back as the reflected beam 58 on the primary fiber 234, i.e. on the fiber tip 240 of the primary fiber 234. In such situation, if the reflected beam 58 is well corrected, and if the radius of curvature of the surface is much larger than the beam focus diameter, then most of the light from the reflected beam 58 will go back into the primary fiber 234 and almost nothing will go into the auxiliary fibers 238.

In focus condition one and surface normal position two, paraxial optics indicate that the reflected beam 58 is still refocused back to the primary fiber 234. However, in this situation, the reflected beam 58 will be shifted in the pupil so that small shifts of the target surface will simply reduce the amount of power back into the primary fiber 234, while large shifts can completely eject the reflected beam 58 from the optical system.

In focus condition two and surface normal position one, the reflected beam 58 is again focused back onto the primary fiber 234 much like the first case above.

In focus condition two and surface normal position two, (assuming small shifts of the surface) the reflected beam 58 is still focused (paraxially) in the plane of the primary fiber 234, but with a shift that is equal to twice the displacement of the beam axis relative to the surface center of curvature times whatever magnification is being used. In such situation, a motion to the spot back on the optical fiber array 22 is provided so that light accepted by the auxiliary fibers 238 can provide information about the position of the surface being investigated.

In focus condition three and surface normal position one, the reflected beam 58 is not focused back on the primary fiber 234, but if the defocus at the surface is slight, then there will still be a small spot returned to the optical fiber array 22 that is, nonetheless, centered on the fiber optic array 22. This can be a useful situation because optical power that reaches the auxiliary fibers 238 is symmetrically distributed among them (i.e. when the auxiliary fibers 238 are also symmetrically distributed about the primary fiber 234), which indicates that the focused beam 46 is centered on the surface.

In focus condition three and surface normal position two, the defocused spot back at the fiber optic array 22 is displaced, which provides asymmetric distribution of power to the auxiliary fibers 238, and thus provides valuable information about the shift of the focused beam 46 relative to the surface.

As illustrated in FIG. 1, the focused beam 46 is focused at a first position. More specifically, as shown, the focused beam 46 is directed in a decentered manner relative to the target 54 (i.e. away from the center of the target and/or toward one side of the target 54), and the spread of the focused beam 46 as it impinges on the target 54 indicates that the focused beam 46 is focused at a point a distance away from the target 54, i.e. beyond or farther away from the measurement assembly 12 than the target 54 (or the surface 16 of the object 10) in this example. Stated in another manner, the focused beam 46 is at focus condition three and surface normal position two.

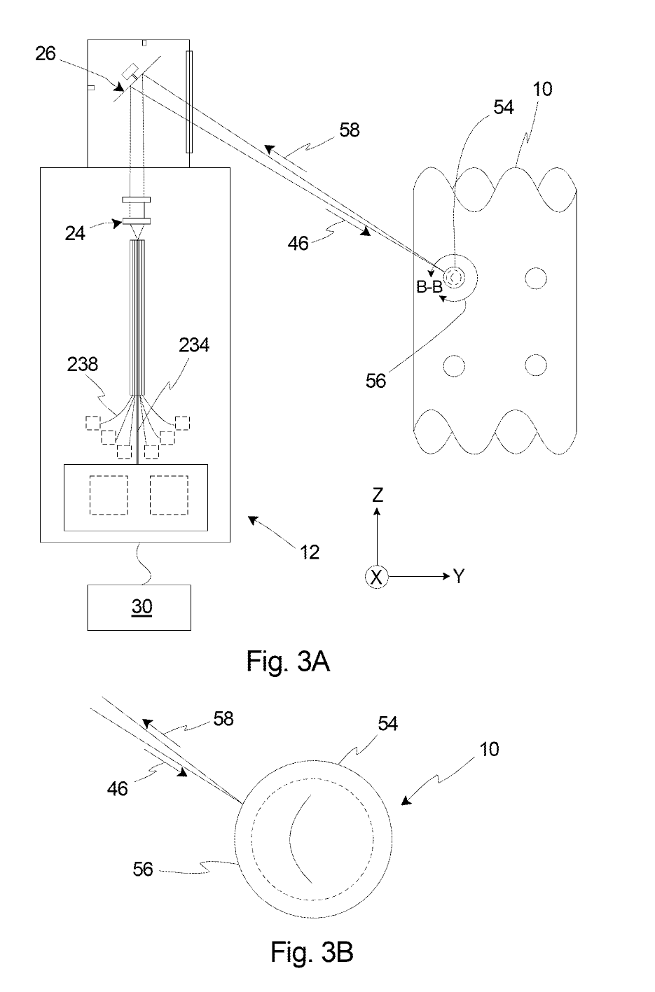

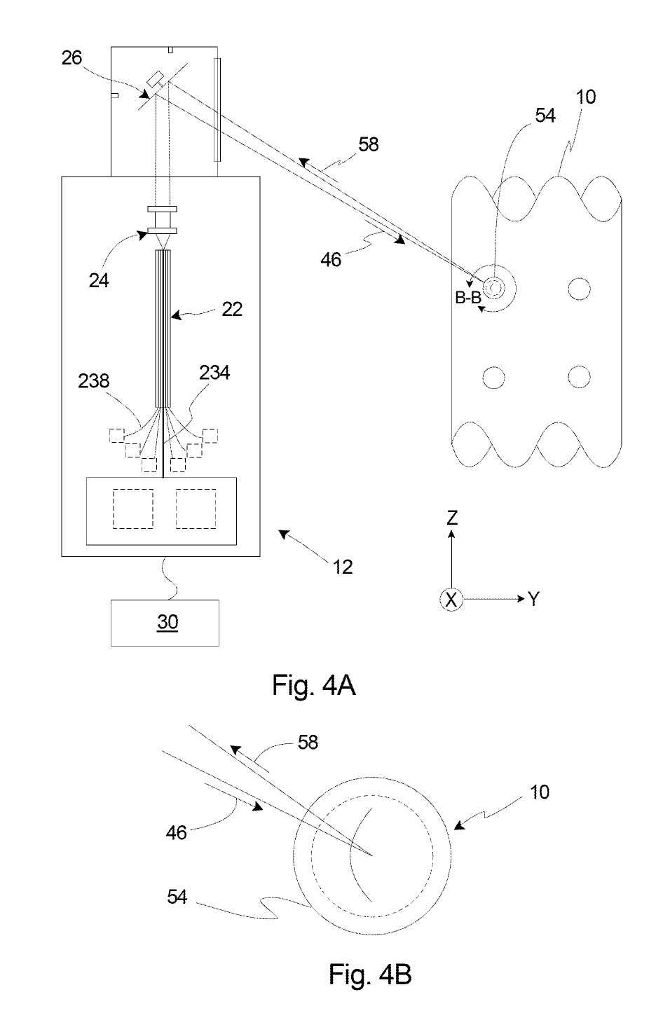

Focusing of the focused beam 46 in a decentered manner relative to the target 54 and/or at a point away from the target 54 is undesired for purposes of accurately and precisely measuring the object 10. Accordingly, as provided herein, certain elements of the measurement assembly 12, e.g., the optical elements 44 of the optical assembly 24, and/or the beam steering assembly 26, can be selectively adjusted under control of the control system 30 so that the focused beam 46 is steered and focused accurately and precisely as desired. In particular, by adjusting the relative position of the optical elements 44 of the optical assembly 24 with the control system 30, the distance of focus of the focused beam 46 can be adjusted; and by adjusting the azimuth and/or elevation angles of the beam steering assembly 26 with the control system 30, the direction of focus of the focused beam 46 can be adjusted. In certain alternative embodiments, it can be desired to focus the focused beam 46 in a centered manner relative to the target 54 precisely on the target surface 56 (as shown in FIGS. 3A and 3B), and/or it can be desired to focus the focused beam 46 in a centered manner relative to the target 54 and at the center of curvature of the target 54 (as shown in FIGS. 4A and 4B).

As noted above, after impinging on the target surface 56, the focused beam 30 is reflected and/or scattered back toward the measurement assembly 12, i.e. back toward the beam steering assembly 26 in this embodiment, as the reflected beam 58. Subsequently, in this embodiment, the beam steering assembly 26 redirects the reflected beam 58 back toward the optical assembly 24, which, in turn, focuses the reflected beam 58 back toward the second array end 33B of the fiber optic array 22, i.e. toward the primary fiber 234 and/or the plurality of auxiliary fibers 238.

Referring again to FIG. 2, as the reflected beam 58 (illustrated in FIG. 1) is redirected toward the fiber optic array 22, the reflected beam 58 is directed toward one or more of the primary fiber 234 and the plurality of auxiliary fibers 238. More particularly, the reflected beam 58 will be focused by the optical assembly 24 on one or more of (i) the fiber tip 240 of the primary fiber 234 (any light from the reflected beam 58 that is focused onto the fiber tip 240 of the primary fiber 234 and/or enters into the primary fiber 234 can also be referred to as a measurement beam 58M (which is illustrated with a long dashed line within the primary fiber 234, and with an arrow in FIG. 1)), and (ii) a fiber tip 260 of one or more of the auxiliary fibers 238.

Whether or not the reflected beam 58 lands precisely on the fiber tip 240 of the primary fiber 234 depends on the curvature and relative slope of the target surface 56 (illustrated in FIG. 1) at the point at which the focused beam 46 (illustrated in FIG. 1) impinges on the target surface 56. If the focused beam 46 has been directed precisely at the spherical target 54 (so that the beam is symmetrically incident on the surface about the normal to the surface and focused on the surface, or so that the beam is focused at the center of curvature of the surface), i.e. with no decentering, then the bulk of the reflected beam 58, or all of a perfectly corrected beam, will be directed back precisely onto the fiber tip 240 of the primary fiber 234. Additionally, in such situation, almost (if not completely) no light from the reflected beam 58 will be directed into the auxiliary fibers 238. Moreover, even if a small amount of light from the reflected beam 58 is directed into the auxiliary fibers 238, such light will be symmetrically distributed to each of the auxiliary fibers 238 when the auxiliary fibers 238 are evenly distributed about the primary fiber 234.

Referring again back to FIG. 1, as illustrated, the primary fiber 234 and the plurality of auxiliary fibers 238 of the fiber optic array 22 are each coupled to the detector assembly 28. In particular, in this embodiment, the primary fiber 234 and the plurality of auxiliary fibers 238 are each coupled to a separate detector of the detector assembly 28, i.e. the primary fiber 234 is coupled to a primary detector 62 and each of the auxiliary fibers 238 is coupled to a separate auxiliary detector 64. Alternatively, the primary fiber 234 and the plurality of auxiliary fibers 238 can each be coupled to a common detector array, e.g., a CCD detector array, of the detector assembly 28 which is adapted to measure the amount of light in each fiber.

Further, in one embodiment, the primary detector 62 and the light source 20 can be positioned within a common housing 66. In such embodiment, the primary fiber 234 can be coupled to the housing 66, and, in turn, individually coupled to each of the primary detector 62 and the light source 20. Alternatively, the primary detector 62 and the light source 20 need not be positioned together within the common housing 66.

The light from the reflected beam 58 that is directed onto the fiber tip 240 (illustrated in FIG. 2) of the primary fiber 234, i.e. the measurement beam 58M, traverses the length of the primary fiber 234 back toward the housing 66. At or near the time (or position) that the measurement beam 58M reaches the housing 66 (i.e. prior to the measurement beam 58M reaching the light source 20), the measurement beam 58M can be diverted, e.g., with a beam splitter (not illustrated), such that the measurement beam 58M is directed toward the primary detector 62 and away from the light source 20. The measurement beam 58M is thus detected by the primary detector 62 and a primary signal is generated.

It should be noted that the primary fiber 234 and the auxiliary fibers 238 are illustrated as they are in FIG. 1, i.e. with the primary fiber 234 being wider than the auxiliary fibers 238, for purposes of clarity and ease of discussion. No limitations on the intended breadth and scope of the present invention are intended from such illustrations.

Additionally, any light from the reflected beam 58 that is directed onto the fiber tips 260 (illustrated in FIG. 2) of one or more of the auxiliary fibers 238 traverse the length of the auxiliary fiber(s) 238 toward the associated auxiliary detector(s) 64. The light from the reflected beam 58 thus reaching one or more of the auxiliary detectors 64 is detected by such auxiliary detectors 64 and one or more auxiliary signals are generated. Stated in another manner, a separate auxiliary signal is generated for each auxiliary fiber 238 into which some of the light from the reflected beam 58 has been directed.

As noted above, when the focused beam 46 is directed at the target 54 with no decentering, then an equal amount of light from the reflected beam 58 will be directed onto the fiber tips 260 of each of the auxiliary fibers 238. Thus, in such situation, an equal auxiliary signal will be generated from each auxiliary detector 64. For example, in one embodiment, when the reflected beam 58 is directed back precisely onto the fiber tip 240 of the primary fiber 234, no auxiliary signal, i.e. an auxiliary signal of zero, will be generated within each of the auxiliary fibers 238.

However, in a situation as illustrated in FIG. 1 where the focused beam 46 is directed in a decentered manner relative to the target 54, different value or intensity of auxiliary signals will be generated in one or more of the auxiliary detectors 64. Stated in another manner, if the focused beam 46 is directed in a decentered manner relative to the target 54, the reflected beam 58 will produce more or less light in the various auxiliary fibers 238 (thus resulting in greater or lesser auxiliary signals) depending on the direction and amount of decentering, as the auxiliary fibers 238 pick up light that has been shifted away from the primary fiber 234 due to the focused beam 46 being directed somewhat off-center at the target 54. Subsequently, an evaluation and/or comparison of the different auxiliary signals generated within the auxiliary fibers 238 can be used to estimate the amount of decentering, or as a feedback to a centering algorithm within the control system 30 so that the beam steering assembly 26 can be adjusted as necessary such that the focused beam 46 is precisely steered toward the center of the target 54. For example, by comparing auxiliary signals that have been generated from auxiliary detectors 64 related to auxiliary fibers 238 on opposite sides of the primary fiber 234, the control system 30 can effectively determine the direction of decentering. Having determined the direction of decentering, the control system 30 can thus control the movement of the beam steering assembly 26, i.e. adjust the azimuth angle and/or the elevation angle, so that focused beam 46 can be moved such that it is no longer directed in a decentered manner relative to the target 54. Thus, with this design, by using the auxiliary signals that are generated based on the amount of light from the reflected beam 58 in each of the auxiliary fibers 238, the direction of focus of the focused beam 46 can be adjusted as desired. Accordingly, if a user knows approximately but not exactly where the target 54 is, the auxiliary signals that are generated from any light being directed into the auxiliary fibers 238, e.g., in differing amounts, can be utilized by the control system 30 to determine how decentered the focus of the focused beam 46 is relative to the target 54. Subsequently, the control system 30 can adjust the position of the beam steering assembly 26 so that the focused beam 46 can be focused more properly as desired in a centered manner relative to the target 54.

Additionally, in a situation as illustrated in FIG. 1 where the focused beam 46 is focused at a point a distance away from the target 54, the reflected beam 58 returning to the optical fiber assembly 22 will be wider, thus resulting in less light from the reflected beam 58 being directed into the primary fiber 234. Accordingly, the primary signal that is generated at the primary detector 62 will be less (e.g., lower power and/or intensity) than a desired maximum value that can be achieved if the focused beam 46 is properly focused at the target 54. Recognizing that the primary signal is less than the desired maximum value, the control system 30 can then control the movement and/or position of the optical elements 44 of the optical assembly 24 so that the focused beam 46 can be properly focused at the target 54.

It should be noted that, in certain embodiments, the reference beam 42 that has been provided within the measurement system 12, as described above, can also be directed toward the primary detector 62, with a corresponding reference signal being generated. Alternatively, the reference beam 42 can be directed to another detector for purposes of generating the reference signal.

Moreover, in certain embodiments, the measurement beam 58M and the reference beam 42 can be combined and/or interfered with one another to provide a measurement signal. In such embodiments, the measurement signal can be utilized to determine the distance to the target 54 and/or the object 10, i.e. the features 14A of the object 10. Additionally and/or alternatively, the primary signal and the reference signal can be evaluated in other manners to determine the distance to the target 54 and/or the object 10, i.e. the features 14A of the object 10.

Examples of measurement systems that use interference of beams are disclosed in U.S. Pat. Nos. 4,733,609; 4,824,251; 4,830,486; 4,969,736; 5,114,226; 7,139,446; 7,925,134; and Japanese Patent No. 2,664,399 which are incorporated by reference herein. Another non-exclusive example is disclosed in US published application US2006-0222314 (which is incorporated by reference herein).

Further, by getting the angle readings from the encoders 50 that relate to the properly focused beam 46, the direction toward the target 54 and/or the object 10, i.e. the features 14A of the object 10, can be determined. Accordingly, by combining the information regarding the distance to the target 54 and/or the object 10 from the measurement signal, and the angled direction toward the target 54 and/or the object 10, the three-dimensional location of the target 54 and/or the object 10 can be measured.

Moreover, in one application, as noted above, once the focused beam 46 has been accurately centered on the target 54, the measurement assembly 12 can then be utilized to track any movement of the object 10 by tracking the movement of the target 54. More specifically, the control system 30 can control the beam steering assembly 26 so that the focused beam 46 can be locked in on and track the movement of the target 54, which, in turn, enables the measurement assembly 12 to effectively track the movement of the object 10 to which the target 54 is secured. Further, such tracking of the object 10 can be effectively accomplished without the need for w-scanning features or other similar features.

It should be noted that if the fiber optic array 22 includes only one fiber, i.e. includes only the primary fiber 234, then the primary signal generated within the primary fiber 234 from the reflected beam 58 is again reduced when the focused beam 46 is decentered as it strikes the target 54. However, in such situation, while the reduced signal generated within the primary fiber 234 may provide some information about the amount of decentering, it provides no useful information about the distance or direction of decentering. Conversely, by utilizing the plurality of auxiliary fibers 238 positioned to substantially encircle the primary fiber 234, as is done with the present invention, precise and accurate information about the amount and direction of decentering can be determined.

FIG. 3A is another simplified schematic illustration of the object 10 and the measurement assembly 12 of FIG. 1. However, in FIG. 3A, the focused beam 46 that is provided by the measurement assembly 12 is now focused at a second position, i.e. in a centered manner relative to the target 54 and precisely on the target surface 56. Stated in another manner, in FIG. 3A, the focused beam 46 is provided at focus condition one and surface normal position one.

More particularly, based on the feedback that is provided to the control system 30 due to the unique design of the present invention, the optical assembly 24 and/or the beam steering assembly 26 have been adjusted as necessary (i.e. relative to the first position illustrated in FIG. 1) so that the focused beam 46 is focused in a centered manner relative to the target 54 and precisely on the target surface 56. Additionally, as illustrated, the light that is reflected off of and/or scattered from the target surface 56 as the reflected beam 58 is directed precisely onto the fiber tip 240 (illustrated in FIG. 2) of the primary fiber 234.

FIG. 3B is an enlarged view of a portion of the object 10 and the focused beam 46 (as indicated by a circle and reference “B-B” in FIG. 3A), with the focused beam 46 shown impinging on the target surface 56 of the target 54.

When the focused beam 46 is precisely focused on the target surface 56, as discussed above, the light from the reflected beam 58 is focused back precisely on the fiber tip 240 (illustrated in FIG. 2) of the primary fiber 234 (illustrated in FIG. 3A). Additionally, in such situation, an equal amount of light from the reflected beam 58 is directed onto the fiber tips 260 (illustrated in FIG. 2) of each of the auxiliary fibers 238 (illustrated in FIG. 3A). For example, in one embodiment, each auxiliary fiber 238 can receive no light from the reflected beam 58. Further, as noted above, with the present design, when each of the auxiliary fibers 238 is shown to have received the same amount of light from the reflected beam 58, then it can be effectively determined that the focused beam 46 has been directed at the target 54 in a centered manner. Stated in another manner, in such situation, the focused beam 46 can be said to be normally incident on the surface 56. Moreover, by focusing the focused beam 46 on the surface 56 of the target 54 and with normal incidence relative to the surface 56 of the target 54, certain benefits can be attained, such as described herein above.

FIG. 4A is still another simplified schematic illustration of the object 10 and the measurement assembly 12 of FIG. 1. However, in FIG. 4A, the focused beam 46 that is provided by the measurement assembly 12 is now focused at a third position, i.e. in a centered manner relative to the target 54 and at the center of curvature of the target 54. Stated in another manner, in FIG. 4A, the focused beam 46 is provided at focus condition two and surface normal position one.

More particularly, based on the feedback that is provided to the control system 30 due to the unique design of the present invention, the optical assembly 24 and/or the beam steering assembly 26 have been adjusted as necessary (i.e. relative to the first position illustrated in FIG. 1) so that the focused beam 46 is focused in a centered manner relative to the target 54 and at the center of curvature of the target 54. Additionally, as illustrated, the light that is reflected off of and/or scattered from the surface of the target 54 as the reflected beam 58 is again directed precisely onto the fiber tip 240 (illustrated in FIG. 2) of the primary fiber 234.

FIG. 4B is an enlarged view of a portion of the object 10 and the focused beam 46 (as indicated by a circle and reference “B-B” in FIG. 4A), with the focused beam 46 shown impinging on the surface of the target 54.

When the focused beam 46 is precisely focused at the center of curvature of the target 54, the rays from the focused beam 46 appear to be converging toward the center of curvature of the target 54, and each ray impinges on the surface of the target 54 at normal incidence. With each ray at normal incidence, the light from the reflected beam 58 will go back on itself (i.e. retrace its path) and be focused back precisely on the fiber tip 240 (illustrated in FIG. 2) of the primary fiber 234 (illustrated in FIG. 4A). Additionally, in such situation, an equal amount of light from the reflected beam 58 is directed onto the fiber tips 260 (illustrated in FIG. 2) of each of the auxiliary fibers 238 (illustrated in FIG. 4A). For example, in one embodiment, each auxiliary fiber 238 can receive no light from the reflected beam 58. Further, as noted above, with the present design, when each of the auxiliary fibers 238 is shown to have received the same amount of light from the reflected beam 58, then it can be effectively determined that the focused beam 48 has been directed at the target 54 in a centered manner. Stated in another manner, in such situation, the focused beam 46 can be said to be normally incident on the surface 56. Moreover, by focusing the focused beam 46 on the center of curvature of the target 54 and with normal incidence relative to the surface 56 of the target 54, certain benefits can be attained, such as described herein above.

For example, when the focused beam 46 is focused on the center of curvature of the target 54, the target 54 acts like another imaging element such that it actually creates an image of the light as a result of the curvature of the target 54. Additionally, the image created due to the focused beam 46 impinging on the surface of the target 54 can have a unit magnification, e.g., a magnification of −1, such that the image is essentially flipped when the reflected beam 58 is reflected or scattered back to the fiber optic array 22. Thus, any movement away from the center of the target 54 can easily be detected because the reflected beam 58 will provide more light in the auxiliary fibers 238 opposite the direction of decentering of the focused beam 46 on the target 54.

It should be noted that in different embodiments, the accuracy range of the measurement assembly 12 can vary. For example, in one embodiment, the measurement assembly 12 can demonstrate enhanced precision within a range of up to approximately thirty meters. Alternatively, in one embodiment, the measurement assembly 12 can demonstrate enhanced precision within a range of up to approximately fifty meters. Additionally and/or alternatively, in some embodiments, the measurement assembly 12 can demonstrate enhanced precision within ranges of less than thirty meters, between thirty and fifty meters, and/or greater than fifty meters.

Next, explanations will be made with respect to a structure manufacturing system provided with the measuring apparatus (metrology system 18) described hereinabove.

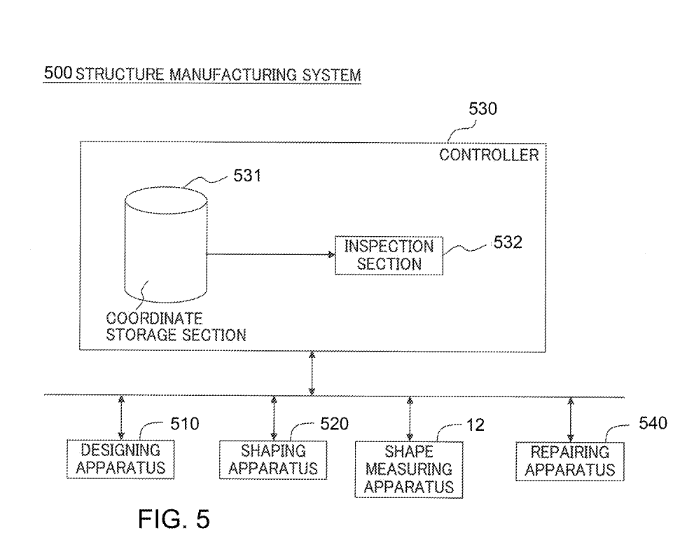

FIG. 5 is a block diagram of a non-exclusive example of a structure manufacturing system 500. The structure manufacturing system is for producing at least a structure from at least one material such as a ship, airplane and so on, and inspecting the structure by the profile measuring apparatus 12. The structure manufacturing system 500 of the embodiment includes the profile measuring apparatus 12 as described hereinabove in the embodiment, a designing apparatus 510, a shaping apparatus 520, a controller 530 (inspection apparatus), and a repairing apparatus 540. The controller 530 includes a coordinate storage section 531 and an inspection section 532.

The designing apparatus 510 creates design information with respect to the shape of a structure and sends the created design information to the shaping apparatus 520. Further, the designing apparatus 510 causes the coordinate storage section 531 of the controller 530 to store the created design information. The design information includes information indicating the coordinates of each position of the structure.

The shaping apparatus 520 produces the structure based on the design information inputted from the designing apparatus 510. The shaping process by the shaping apparatus 520 includes such as casting, forging, cutting, and the like. The profile measuring apparatus 12 measures the coordinates of the produced structure (measuring object) and sends the information indicating the measured coordinates (shape information) to the controller 530.

The coordinate storage section 531 of the controller 530 stores the design information. The inspection section 532 of the controller 530 reads out the design information from the coordinate storage section 531. The inspection section 532 compares the information indicating the coordinates (shape information) received from the profile measuring apparatus 12 with the design information read out from the coordinate storage section 531. Based on the comparison result, the inspection section 532 determines whether or not the structure is shaped in accordance with the design information. In other words, the inspection section 532 determines whether or not the produced structure is nondefective. When the structure is not shaped in accordance with the design information, then the inspection section 532 determines whether or not the structure is repairable. If repairable, then the inspection section 532 calculates the defective portions and repairing amount based on the comparison result, and sends the information indicating the defective portions and the information indicating the repairing amount to the repairing apparatus 540.

The repairing apparatus 540 performs processing of the defective portions of the structure based on the information indicating the defective portions and the information indicating the repairing amount received from the controller 530.

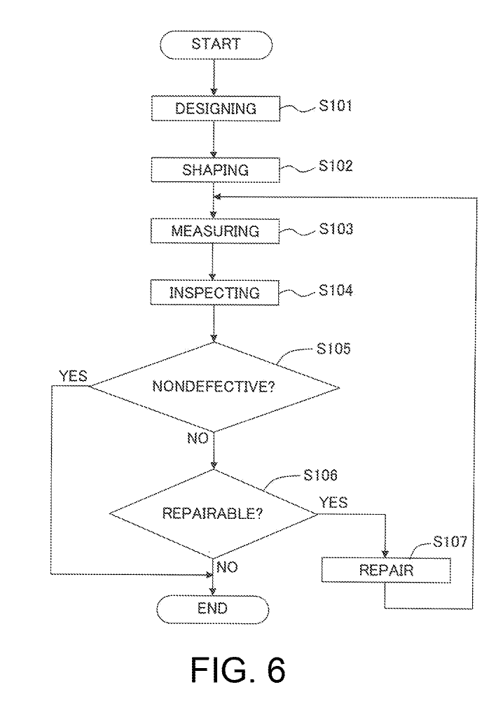

FIG. 6 is a flowchart showing a processing flow of the structure manufacturing system 500. With respect to the structure manufacturing system 500, first, the designing apparatus 510 creates design information with respect to the shape of a structure (step S101). Next, the shaping apparatus 520 produces the structure based on the design information (step S102). Then, the profile measuring apparatus 12 measures the produced structure to obtain the shape information thereof (step S103). Then, the inspection section 532 of the controller 530 inspects whether or not the structure is produced truly in accordance with the design information by comparing the shape information obtained from the profile measuring apparatus 12 with the design information (step S104).

Then, the inspection portion 532 of the controller 530 determines whether or not the produced structure is nondefective (step S105). When the inspection section 532 has determined the produced structure to be nondefective (“YES” at step S105), then the structure manufacturing system 500 ends the process. On the other hand, when the inspection section 532 has determined the produced structure to be defective (“NO” at step S105), then it determines whether or not the produced structure is repairable (step S106).

When the inspection portion 532 has determined the produced structure to be repairable (“YES” at step S106), then the repair apparatus 540 carries out a reprocessing process on the structure (step S107), and the structure manufacturing system 500 returns the process to step S103. When the inspection portion 532 has determined the produced structure to be unrepairable (“NO” at step S106), then the structure manufacturing system 500 ends the process. With that, the structure manufacturing system 500 finishes the whole process shown by the flowchart of FIG. 6.

With respect to the structure manufacturing system 500 of the embodiment, because the profile measuring apparatus 12 in the embodiment can correctly measure the coordinates of the structure, it is possible to determine whether or not the produced structure is nondefective. Further, when the structure is defective, the structure manufacturing system 500 can carry out a reprocessing process on the structure to repair the same.

Further, the repairing process carried out by the repairing apparatus 540 in the embodiment may be replaced such as to let the shaping apparatus 520 carry out the shaping process over again. In such a case, when the inspection section 532 of the controller 530 has determined the structure to be repairable, then the shaping apparatus 520 carries out the shaping process (forging, cutting, and the like) over again. In particular for example, the shaping apparatus 520 carries out a cutting process on the portions of the structure which should have undergone cutting but have not. By virtue of this, it becomes possible for the structure manufacturing system 500 to produce the structure correctly.

In the above embodiment, the structure manufacturing system 500 includes the profile measuring apparatus 12, the designing apparatus 510, the shaping apparatus 520, the controller 530 (inspection apparatus), and the repairing apparatus 540. However, present teaching is not limited to this configuration. For example, a structure manufacturing system in accordance with the present invention can include fewer components than described herein.

While a number of exemplary aspects and embodiments of a measurement assembly 12 have been discussed above, those of skill in the art will recognize certain modifications, permutations, additions and sub-combinations thereof. It is therefore intended that the following appended claims and claims hereafter introduced are interpreted to include all such modifications, permutations, additions and sub-combinations as are within their true spirit and scope.

What is claimed is:

1. A measurement assembly that directs a light beam at a surface, the measurement assembly comprising:
a light source that emits the light beam that is directed at the surface, the light beam being reflected off of the surface to create a reflected beam; and
a fiber optic array having a first array end that receives the reflected beam, the fiber optic array including a primary fiber and at least one auxiliary fiber, wherein the at least one auxiliary fiber is positioned substantially adjacent to the primary fiber at the first array end.

2. The measurement assembly of claim 1 further comprising a detector assembly that is coupled to the fiber optic array; wherein any light from the reflected beam in the primary fiber provides a measurement beam that is detected by the detector assembly to generate a primary signal, and any light from the reflected beam in the at least one auxiliary fiber is detected by the detector assembly to generate at least one auxiliary signal.

3. The measurement assembly of claim 2 further comprising a control system that receives the primary signal and the at least one auxiliary signal, the control system utilizing at least the primary signal to measure a property of the surface.

4. The measurement system of claim 3 further comprising a beam steering assembly that selectively adjusts the position of the light beam relative to the surface, wherein the control system controls the beam steering assembly utilizing the at least one auxiliary signal.

5. The measurement assembly of claim 1 further comprising an optical assembly that is positioned along a beam path of the light beam between the fiber optic array and the surface, the optical assembly focusing the light beam to provide a focused beam that is directed at the surface.

6. The measurement assembly of claim 5 further comprising a detector assembly that is coupled to the fiber optic array, wherein the surface is curved, and wherein any light from the reflected beam in the primary fiber provides a measurement beam that is detected by the detector assembly to generate a primary signal, and any light from the reflected beam in the at least one auxiliary fiber is detected by the detector assembly to generate at least one auxiliary signal, and wherein the at least one auxiliary signal is utilized to center the focused beam on the curved surface.

7. The measurement assembly of claim 5 wherein the surface is part of a spherical target; and wherein the optical assembly is selectively adjustable so that the focused beam is focused on one of the surface of the spherical target and the center of curvature of the spherical target.

8. The measurement assembly of claim 5 wherein the reflected beam is directed toward the optical assembly, the optical assembly focusing the reflected beam onto one or more of the primary fiber and the at least one auxiliary fiber.

9. The measurement assembly of claim 1 wherein the fiber optic array includes a plurality of auxiliary fibers, wherein the plurality of auxiliary fibers are positioned substantially adjacent to and substantially encircle the primary fiber at the first array end.

10. The measurement assembly of claim 9 further comprising a detector assembly that is coupled to the fiber optic array; wherein any light from the reflected beam in the primary fiber provides a measurement beam that is detected by the detector assembly to generate a primary signal, and any light from the reflected beam in the plurality of auxiliary fibers is detected by the detector assembly to generate a plurality of auxiliary signals.

11. The measurement assembly of claim 10 further comprising a beam steering assembly that selectively adjusts the position of the light beam relative to the surface, and a control system that receives the primary signal and the plurality of auxiliary signals, wherein the control system controls the beam steering assembly utilizing the plurality of auxiliary signals.

12. A method for directing a light beam at a surface, the method comprising the steps of:
emitting the light beam from a light source;
directing the light beam at the surface;
reflecting the light beam off of the surface to create a reflected beam; and
receiving the reflected beam with a first array end of a fiber optic array, the fiber optic array including a primary fiber and at least one auxiliary fiber, wherein the at least one auxiliary fiber is positioned substantially adjacent to the primary fiber at the first array end.

13. The method of claim 12 further comprising the step of coupling a detector assembly to the fiber optic array, and wherein the step of receiving includes any light from the reflected beam in the primary fiber providing a measurement beam that is detected by the detector assembly to generate a primary signal, and any light from the reflected beam in the at least one auxiliary fiber being detected by the detector assembly to generate at least one auxiliary signal.

14. The method of claim 13 further comprising the steps of receiving the primary signal and the at least one auxiliary signal with a control system, and measuring a property of the surface with the control system utilizing the at least the primary signal.

15. The method of claim 14 further comprising the steps of selectively adjusting the position of the light beam relative to the surface with a beam steering assembly, and controlling the beam steering assembly with the control system utilizing the at least one auxiliary signal.

16. The method of claim 12 further comprising the steps of focusing the light beam with an optical assembly that is positioned along a beam path of the light beam between the fiber optic array and the surface to provide a focused beam, and directing the focused beam at the surface.

17. The method of claim 16 wherein the surface is curved, and further comprising the steps of (i) coupling a detector assembly to the fiber optic array, wherein any light from the reflected beam in the primary fiber provides a measurement beam that is detected by the detector assembly to generate a primary signal, and any light from the reflected beam in the at least one auxiliary fiber is detected by the detector assembly to generate at least one auxiliary signal; and (ii) centering the focused beam on the curved surface utilizing the at least one auxiliary signal.

18. The method of claim 12 wherein the step of receiving the reflected beam includes the fiber optic array including a plurality of auxiliary fibers that are positioned substantially adjacent to and that substantially encircle the primary fiber at the first array end.

19. The method of claim 18 further comprising the steps of (i) selectively adjusting the position of the light beam relative to the surface with a beam steering assembly; (ii) coupling a detector assembly to the fiber optic array, wherein any light from the reflected beam in the primary fiber provides a measurement beam that is detected by the detector assembly to generate a primary signal, and any light from the reflected beam in the plurality of auxiliary fibers is detected by the detector assembly to generate a plurality of auxiliary signals; and (iii) receiving the primary signal and the plurality of auxiliary signals with a control system, wherein the control system controls the beam steering assembly utilizing the plurality of auxiliary signals.

20. A measurement assembly that directs a light beam at a curved surface, the measurement assembly comprising:
a light source that emits the light beam;
a fiber optic array having a first array end, an opposed second array end, a primary fiber and a plurality of auxiliary fibers, wherein the primary fiber is coupled into and receives the light beam at the first array end, and wherein the plurality of auxiliary fibers are positioned substantially adjacent to and that substantially encircle the primary fiber at the second array end;
an optical assembly that is positioned along a beam path of the light beam between the fiber optic array and the surface, the optical assembly focusing the light beam to provide a focused beam;
a beam steering assembly that directs the focused beam toward the curved surface, the focused beam subsequently being reflected off of the curved surface to provide a reflected beam that is directed toward the optical assembly, wherein the optical assembly focuses the reflected beam onto one or more of the primary fiber and the plurality of auxiliary fibers;
a detector assembly that is coupled to the fiber optic array, wherein any light from the reflected beam in the primary fiber provides a measurement beam that is detected by the detector assembly to generate a primary signal, and any light from the reflected beam in the plurality of auxiliary fibers is detected by the detector assembly to generate a plurality of auxiliary signals; and
a control system that receives the primary signal and the plurality of auxiliary signals, wherein the control system utilizes at least the primary signal to measure a property of the surface, and wherein the control system utilizes the plurality of auxiliary signals to control the beam steering assembly such as to center the focused beam on the curved surface.
